(19) United States
(12) Patent Application Publication
(10) Pub. No.: US 2016/0139734 A1
(43) Pub. Date: May 19, 2016

(54) INPUT DEVICE

(71) Applicant: ALPS ELECTRIC CO., LTD., Tokyo (JP)

(72) Inventors: Satoshi NAKAJIMA, Miyagi-ken (JP); Satoshi HAYASAKA, Miyagi-ken (JP)

(21) Appl. No.: 14/938,120

(22) Filed: Nov. 11, 2015

(30) Foreign Application Priority Data
Nov. 13, 2014 (JP) 2014-231019

(51) Int. Cl. G06F 3/041; G06F 3/044

(52) U.S. Cl. CPC G06F 3/0418; G06F 3/044

(57) ABSTRACT

An input device includes an input operating unit that includes a plurality of capacitance detection units and on which an operating body performs an approach operation, a capacitance measurement unit that measures a capacitance value for each capacitance detection unit and outputs the measured capacitance value as a measurement signal, and a control unit that acquires the measurement signal in association with the capacitance detection unit, updates a base value using the measurement signal, obtains a capacitance change value from a difference between the measurement signal and the base value, and determines whether the capacitance change value exceeds a first threshold value to detect whether or not there is an operation, in which the control unit compares a sum total of the capacitance change values that are negative values with a second threshold value to determine that foreign matter is removed.

### CLAIM OF PRIORITY

This application claims benefit of Japanese Patent Application No. 2014-231019 filed on Nov. 13, 2014, which is hereby incorporated by reference.

### BACKGROUND OF THE INVENTION

1. Field of the Invention

The present invention relates to a capacitive input device and, more particularly, to an input device capable of reducing erroneous detection due to foreign matter or the like.

2. Description of the Related Art

Conventionally, a capacitive input device is used to perform an input operation in which a change in capacitance caused by an approach operation using an operating body such as a finger of an operator or a touch pen is detected, and is widely used in portable devices such as portable phones or tablet type terminals, in-vehicle devices such as a navigation device, or the like.

An approach sensing device 900 described in Japanese Unexamined Patent Application Publication No. 2010-257046 (an example of the related art) includes a touch panel 901 in which sensing electrodes 902a to 902e are arranged, a capacitance detection unit 903, an approach and contact detection unit 904, a baseline updating unit 905, a baseline storage unit 906, and a control unit 907, as illustrated in FIG. 5.

The capacitance detection unit 903 detects a capacitance value between the sensing electrodes 902a to 902e and a finger 908, and the approach and contact detection unit 904 compares a difference value between the capacitance value and a baseline value with an approach reference capacitance value and a contact reference capacitance value to detect an approach and contact state of the finger 908. When the approach and contact detection unit 904 determines that the finger 908 is not in an approach or contact state, the baseline updating unit 905 determines that the finger 908 does not approach based on a difference value distribution, and updates the capacitance value to a new baseline value. Technology in which, when the approach and contact detection unit 904 determines that the finger 908 is in an approach state, or when the baseline updating unit 905 determines that the finger 908 is in the approach state based on the difference value distribution, the baseline updating unit 905 does not update the baseline value is disclosed.

However, in the example of the related art described above, foreign matter such as a coin or a water droplet is not considered.

Accordingly, it cannot be detected that foreign matter such as a coin or a water droplet is placed or removed. When the foreign matter is placed, a user can visually recognize that the foreign matter is placed. However, there is a problem in which, when the foreign matter is removed, the removal of the foreign matter may be recognized as a malfunction.

### SUMMARY OF THE INVENTION

The present invention provides a capacitive input device capable of detecting that foreign matter such as a coin or a water droplet has been removed.

An input device according to an aspect of the present invention includes an input operating unit configured to include a plurality of capacitance detection units, an operating body performing an approach operation on the input operating unit; a capacitance measurement unit configured to measure a capacitance value for each capacitance detection unit and output the measured capacitance value as a measurement signal; and a control unit configured to acquire the measurement signal in association with the capacitance detection unit, update a base value using the measurement signal, obtain a capacitance change value from a difference between the measurement signal and the base value, and determine whether the capacitance change value exceeds a first threshold value to detect whether or not there is an operation, in which the control unit compares a sum total of the capacitance change values that are negative values with a second threshold value to determine that foreign matter is removed.

Accordingly, since the control unit compares the sum total of the capacitance change values that are negative values with the second threshold value to determine that the foreign matter has been removed, it is possible to detect that the foreign matter has been removed by distinguishing between the presence or absence of the operation of the operator and the foreign matter. Further, since the determination is performed using the sum total of the capacitance change values that are negative values, it is possible to prevent a negative component from being output due to sporadic noise and to perform a stabilized determination. Therefore, it is possible to provide the capacitive input device capable of detecting that the foreign matter such as a coin or a water droplet has been removed.

Further, in the input device according to an aspect of the present invention, the control unit may update the base value when the sum total of the capacitance change values that are negative values exceeds the second threshold value.

Accordingly, the control unit updates the base value when the sum total of the capacitance change values that are negative values exceeds the second threshold value. Thus, even when erroneous detection occurs when the foreign matter has been removed, returning from the erroneous detection is possible due to following of the base value.

According to the present invention, it is possible to provide a capacitive input device capable of detecting that foreign matter such as a coin or a water droplet has been removed.

### BRIEF DESCRIPTION OF THE DRAWINGS

FIG. 1 is a block diagram illustrating a configuration of an input device according to an embodiment of the present invention;

FIG. 2 is a schematic view of an appearance of the input device according to an embodiment of the present invention;

FIG. 3 is a flowchart illustrating an operation overview of the input device according to an embodiment of the present invention;

FIGS. 4A and 4B are schematic views illustrating a state of a capacitance detection unit la when capacitance is detected; and

FIG. 5 is a block diagram illustrating a configuration of an input device of the related art.

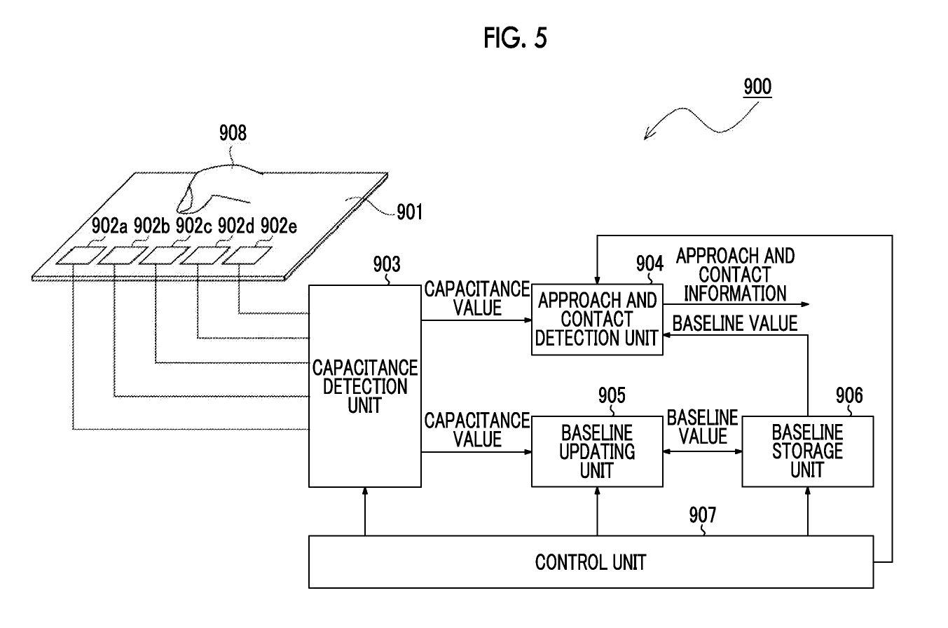

### DESCRIPTION OF THE PREFERRED EMBODIMENTS

### First Embodiment

Hereinafter, an input device 100 in a first embodiment will be described.

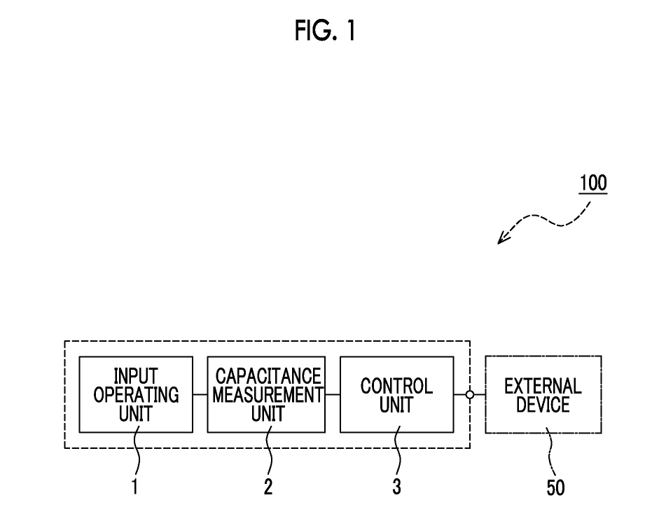

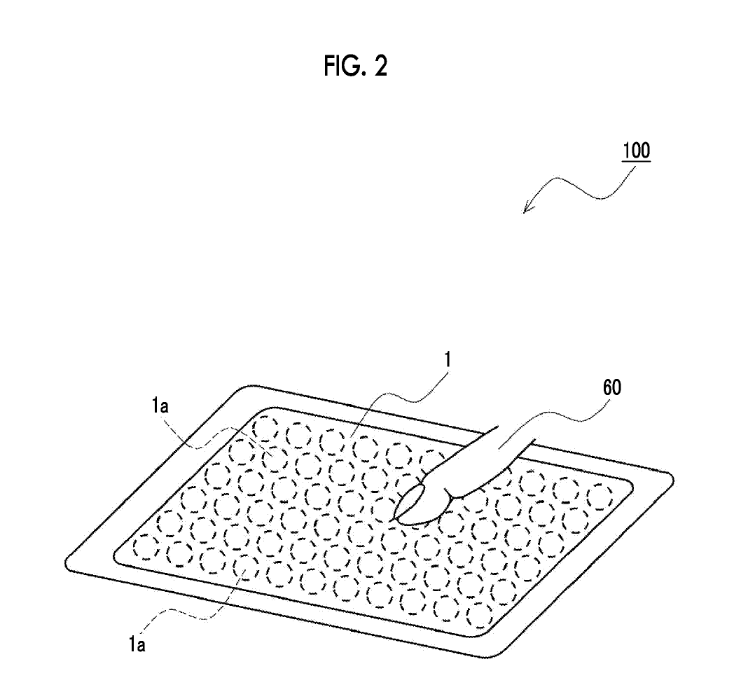

A configuration of the input device 100 in the present embodiment will first be described with reference to FIGS. 1 and 2. FIG. 1 is a block diagram illustrating a configuration of the input device 100. FIG. 2 is a schematic view of an appearance of the input device 100.

The input device 100 includes an input operating unit 1, a capacitance measurement unit 2, and a control unit 3, as illustrated in FIG. 1. The input operating unit 1 is connected to the capacitance measurement unit 2, and the capacitance measurement unit 2 is connected to the control unit 3. The control unit 3 is connected to an external device 50, and outputs a control signal to the external device 50.

In the input operating unit 1, an input operation is performed through an approach operation in which an operating body 60 such as a finger of an operator approaches or contacts an input operation surface, as illustrated in FIG. 2. In the input operating unit 1, a plurality of capacitance detection units 1a are provided along the input operation surface.

The capacitance detection unit la has capacitance. If the operator comes in contact with the input operating unit 1 with the operating body 60 such as a finger so as to perform the input operation, a capacitance value of the capacitance detection unit 1a in a contact position and in the vicinity thereof is changed.

The capacitance measurement unit 2 measures the capacitance of each of the plurality of capacitance detection units 1a, and performs analog-to-digital conversion (hereinafter, referred to as AD conversion) to convert the measured capacitance from an analog signal to a digital signal. Further, the capacitance measurement unit 2 outputs data of the capacitance converted into the digital signal through the AD conversion as a measurement signal ADi to the control unit 3.

The capacitance measurement unit 2 measures the capacitance value of each of the plurality of capacitance detection units 1a, and performs analog-to-digital conversion (hereinafter, referred to as AD conversion) to convert the measured capacitance value from an analog signal to a digital signal. Further, the capacitance measurement unit 2 outputs the capacitance value converted into the digital signal through the AD conversion as a measurement signal ADi to the control unit 3.

The control unit 3 controls the capacitance measurement unit 2 to acquire the measurement signal ADi of each capacitance detection unit 1a in association with coordinate information of the capacitance detection unit 1a. Further, the control unit 3 performs an operation using a value of the measurement signal ADi acquired in association with the coordinate information from the capacitance measurement unit 2, and outputs a control signal to the external device 50 based on a result of the operation. Further, the control unit 3 includes a timer function or a memory (not illustrated), and can perform, for example, management of a control interval using the timer function, and storage of the value of the acquired measurement signal ADi or a result of performing an operation on the value of the measurement signal ADi.

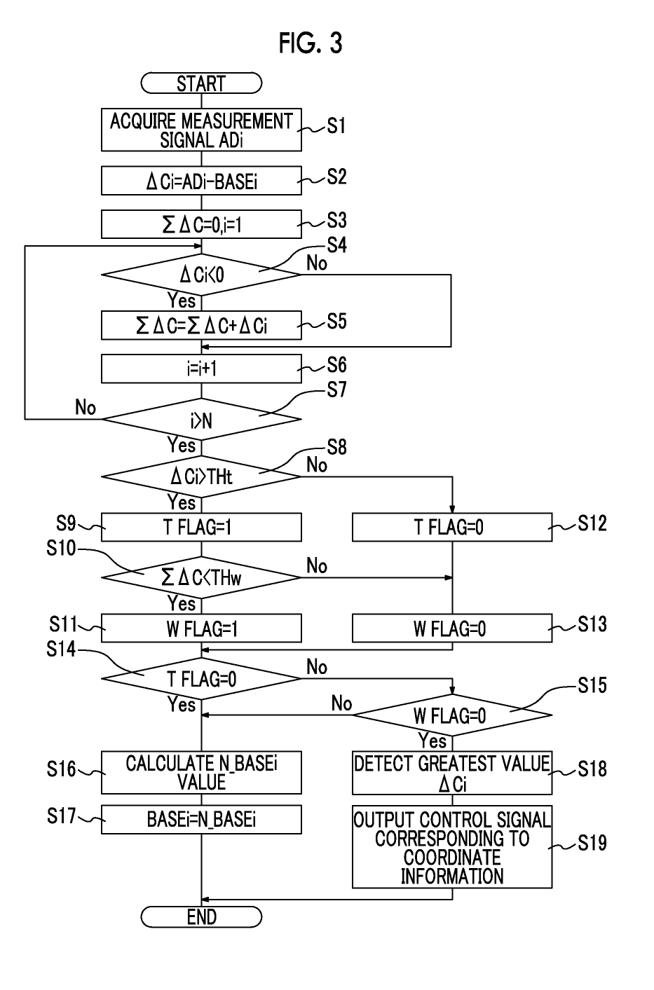

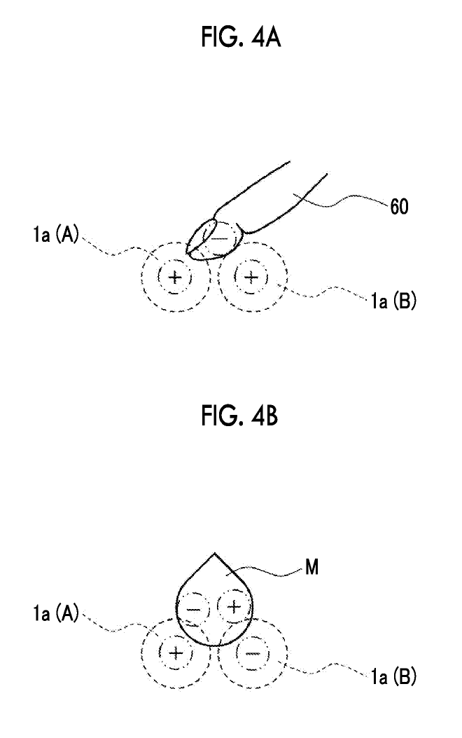

Next, an operation of the input device 100 will be described with reference to FIGS. 3, 4A, and 4B. FIG. 3 is a flowchart illustrating an operation of the input device 100, and an illustrated processing procedure is repeatedly performed in a regular manner using, for example, a timer function built into the control unit 3. FIGS. 4A and 4B are schematic views illustrating a state of the capacitance detection unit 1a when the capacitance is detected. FIG. 4A is a diagram illustrating a state of the capacitance detection unit 1a when the operating body 60 comes in contact with the input operating unit 1, and FIG. 4B is a diagram illustrating a state of the capacitance detection unit 1a when a foreign matter M such as a coin or a water droplet comes in contact with the input operating unit 1. A first threshold value THt for determining whether or not there is an operation on the input operating unit 1, a second threshold value THw for determining that a coin or water has been removed, and an initial value of a base value (BASE) for calculating a capacitance change value are stored in the memory included in the control unit 3 in advance. Further, in the following description, an initial value of a flag or the like indicating a result of determining an operation state is set to “0”. N capacitance detection units la are provided in the input operating unit 1, and values regarding an i-th capacitance detection unit la among the N capacitance detection units la are expressed as a measurement signal ADi, a capacitance change value ΔCi, and a base value BASEi.

First, the control unit 3 controls the capacitance measurement unit 2 to sequentially acquire values of the measurement signals (ADi: i=1 to N) from all the capacitance detection units 1a in step 51. The acquired measurement signals ADi are stored in a measurement signal storage area set in the memory included in the control unit 3 in association with the coordinate information of the capacitance detection unit 1a. The process proceeds to step S2.

When the capacitance measurement unit 2 detects the capacitance of the capacitance detection unit 1a in step 51, the capacitance measurement unit 2 sequentially outputs a signal for detecting the capacitance to the respective capacitance detection unit 1a. When the operating body 60 performs an input operation in the input operating unit 1, if a+ (positive) detection signal is applied to a side indicated by (A) of the capacitance detection unit 1a as illustrated in FIG. 4A, the operating body 60 is charged with a relatively − (negative) charge. Accordingly, a + (positive) signal is detected by the capacitance detection unit 1a indicated by (B), which is located near the operating body 60.

When the foreign matter M, such as a coin or a water droplet, is placed on the input operating unit 1, if a + (positive) detection signal is applied to a side indicated by (A) of the capacitance detection unit 1a as illustrated in FIG. 4B, the foreign matter M is electrically polarized. Accordingly, a − (negative) signal is detected by the capacitance detection unit 1a indicated by (B), which is located near the foreign matter M.

Since such a phenomenon occurs, when the operating body 60 such as a finger performs the input operation, if the number of the capacitance detection units 1a in a location in which the operating body 60 performs the input operation increases, the capacitance of the neighboring capacitance detection unit 1a also increases. When the foreign matter M is placed, a portion in which the capacitance increases and a portion in which the capacitance decreases are generated due to an influence of the polarization of the foreign matter M. While FIG. 4 is shown as a simplified schematic diagram in which the number of capacitance detection units 1a is only two in order to assist in understanding, the same phenomenon actually occurs in the neighboring capacitance detection units 1a.

In a state in which there is the foreign matter M such as a coin or a water droplet on the input operating unit 1, if the base value BASEi is updated, the base value BASEi in the portion in which the capacitance increases becomes a great value, and the base value BASEi in the portion in which the capacitance decreases becomes a small value. In a state in which the base value follows the state in which there is the foreign matter M, if the foreign matter M is removed, the capacitance is measured to decrease in the portion in which the base value increases, and the capacitance is measured to increase in the portion in which the base value decreases.

In step S2, the control unit 3 obtains a capacitance change value ΔCi from a difference between the measurement signal ADi acquired in step 51 and the base value BASEi of each capacitance detection unit 1a stored in the memory. The base value BASEi is set to a value close to the capacitance value of each capacitance detection unit la when there is no input operation. Therefore, the capacitance change value ΔCi becomes a positive value when the capacitance of the capacitance detection unit 1a increases and the value of the measurement signal ADi increases, and becomes a negative value when the capacitance of the capacitance detection unit la decreases and the value of the measurement signal ADi decreases. The calculated capacitance change value ΔCi is stored in a storage area for the capacitance change value ΔCi set in the memory included in the control unit 3 in association with the coordinate information of the capacitance detection unit 1a, and the process proceeds to step S3.

In step S3, in order to perform an operation on the capacitance change value ΔCi calculated in step S2, the control unit 3 sets 0 (zero) to a value of a sum ΣΔC and sets “1” to a value of a counter (i) that counts the number of times of summation, and the process proceeds to step S4.

In step S4, the control unit 3 checks a sign of the capacitance change value ΔCi of the capacitance detection unit la corresponding to the value of the counter (i), and proceeds to step S5 when the value is a negative value, and step S6 when the value is not a negative value.

In step S5, the control unit 3 adds the capacitance change value ΔCi of the capacitance detection unit la corresponding to the value of the counter (i) to the value of the sum ΣΔC, and proceeds to step S6.

In step S6, the control unit 3 adds “1” to the value of the counter (i) and proceeds to step S7.

In step S7, the control unit 3 compares the value of the counter (i) with the number “N” of the capacitance detection units 1a, and proceeds to step S8 when the value of the counter value (i) exceeds “N”. When the value of the counter (i) is equal to or smaller than “N”, the control unit 3 returns to step S4 to check the sign of the capacitance change value ΔCi of the capacitance detection unit la corresponding to the updated value of the counter (i). Then, steps S4 to S7 are repeated until the value of the counter (i) is greater than the number “N” of the capacitance detection units 1a, similarly to the above. Accordingly, the capacitance values ΔCi of the capacitance detection units la that are negative values are all summed in the sum ΣΔC, and a sum total is obtained.

In step S8, the control unit 3 compares the capacitance change value ΔCi corresponding to each capacitance detection unit 1a calculated in step S2 with a first threshold value THt for determining whether or not there is an operation on the input operating unit 1. As a result of the comparison, the control unit 3 proceeds to step S9 when the capacitance change value ΔCi exceeds the first threshold value THt, and step S12 when the capacitance change value ΔCi does not exceed the first threshold value THt.

In step S9, the control unit 3 sets “1” indicating that there is an operation in a T flag indicating whether or not there is an operation on the input operating unit 1, stores the T flag in the memory, and proceeds to step S10.

In step S10, the control unit 3 compares the sum ΣΔC that is a sum total of the capacitance change values ΔCi that are negative values calculated in steps S4 to step S7 with a second threshold value THw for determining that the foreign matter such as a coin or water has been removed. As a result of the comparison, the control unit 3 proceeds to step S11 when the sum ΣΔC exceeds the second threshold value, and step S13 when the sum ΣΔC does not exceed the second threshold value. The sum ΣΔC that is a sum total of the capacitance change values ΔCi that are negative values is a negative value, the second threshold value is set as a negative value, and the sum ΣΔC exceeds the second threshold value in the case of a smaller value than the second threshold value.

In step S11, the control unit 3 sets “1” indicating that removal of the foreign matter has been detected in a W flag indicating whether or not the foreign matter has been removed on the input operating unit 1, stores the W flag in the memory, and proceeds to step S14.

In step S12, since it is determined in step S8 that the capacitance change value ΔCi does not exceed the first threshold value THt, the control unit 3 sets “0” (zero) indicating that there is no operation in the T flag indicating whether or not there is an operation on the input operating unit 1, stores the T flag in the memory, and proceeds to step S13.

Step S13 is performed subsequent to step S9 when it is determined in step S8 that the capacitance change value ΔCi does not exceed the first threshold value THt or when it is determined in step S10 that the sum ΣΔC that is a sum total of the capacitance change values ΔCi that are negative values does not exceed the second threshold value. Since it is determined in any case that there is no operation in the input operating unit 1 or erroneous detection of the operation due to the removal of the foreign matter, the control unit 3 sets “0” (zero) indicating that removal of the foreign matter has not been detected in the W flag indicating whether or not the foreign matter has been removed, stores the W flag in the memory, and proceeds to step S14.

In step S14, the control unit 3 checks the T flag indicating whether or not there is an operation, and proceeds to step S16 when “0” is set and step S15 when “1” is set.

In step S15, the control unit 3 checks the W flag indicating whether or not the foreign matter has been removed, and proceeds to step S18 when “0” is set and step S16 when “1” is set.

Step S16 is performed when the T flag indicating whether or not there is an operation is “0” in step S14 or when the T flag is 1 and the W flag indicating whether or not the foreign matter has been removed is “1” in step S15. In other words, step S16 is performed when there is no operation in the input operating unit 1, or when it is determined that the operation has been detected, but the erroneous detection is generated due to removal of the foreign matter. Accordingly, the control unit 3 calculates a new base value N_BASEi for each capacitance detection unit la so as to update the base value using the measurement signal ADi, stores the new base value in the memory included in the control unit 3, and proceeds to step S17.

In step S17, the control unit 3 updates the new base value N_BASEi obtained in step S16 to be the base value BASEi, stores the base value, and ends the process.

Step S18 is performed when the T flag indicating whether or not there is an operation is “1” in step S14 and the W flag indicating whether or not the foreign matter has been removed is “0” in step S15. In other words, step S18 is performed when it is determined that there is an operation on the input operating unit 1, and erroneous detection is not detected in spite of the removal of the foreign matter. Accordingly, the control unit 3 checks the capacitance change value ΔCi having the greatest value, and proceeds to step S19.

In step S19, the control unit 3 outputs a control signal corresponding to the coordinate information of the capacitance change value ΔCi that is the greatest value obtained in step S18, and ends the process.

Hereinafter, effects of the present embodiment will be described.

The input device 100 of this embodiment includes the input operating unit 1 that includes the plurality of capacitance detection units 1a and on which the operating body 60 performs the approach operation, the capacitance measurement unit 2 that measures the capacitance value for each capacitance detection unit 1a and outputs the measured capacitance value as the measurement signal ADi, and the control unit 3 that acquires the measurement signal ADi in association with the capacitance detection unit 1a, updates the base value BASEi using the measurement signal ADi, obtains the capacitance change value ΔCi from a difference between the measurement signal ADi and the base value BASEi, and determines whether the capacitance change value ΔCi exceeds the first threshold value THt to detect whether or not there is an operation, in which the control unit 3 compares the sum ΣΔC that is a sum total of the capacitance change values ΔCi that are negative values with a second threshold value THw to determine that foreign matter has been removed.

Accordingly, since the control unit 3 compares the sum ΣΔC that is a sum total of the capacitance change values ΔCi that are negative values with the second threshold value THw to determine that the foreign matter M has been removed, it is possible to detect that the foreign matter M has been removed by distinguishing between the presence or absence of the operation of the operator and the foreign matter M. Further, since the determination is performed using the sum ΣΔC that is a sum total of the capacitance change values that are negative values, it is possible to prevent a negative component from being output due to sporadic noise and to perform a stabilized determination. Therefore, it is possible to provide the capacitive input device capable of detecting that the foreign matter M such as a coin or a water droplet has been removed.

Further, in the input device 100 of the present embodiment, the control unit 3 updates the value base BASEi when the sum ΣΔC that is a sum total of the capacitance change values ΔCi that are negative values exceeds the second threshold value THw.

Accordingly, the control unit 3 updates the base value BASEi when the sum ΣΔC that is a sum total of the capacitance change values that are negative values exceeds the second threshold value THw. Thus, even when erroneous detection occurs when the foreign matter has been removed, returning from the erroneous detection is possible due to following of the base value BASEi.

While the input device 100 according to an embodiment of the present invention has been described in detail as described above, the present invention is not limited to the above embodiment and may be implemented with various modifications without departing from the scope of the present invention. For example, the present invention may be implemented with various modifications as follows, and these embodiments also fall within the technical scope of the present invention.

(1) In the present embodiment, while the description has been given without showing specific values of the first threshold value THt, the second threshold value THw, or the like used in the control unit 3, it is preferable to implement the present invention using appropriate values set according to a device into which the input device is to be assembled or an assumed use state. The present invention may be implemented with correction or the like according to, for example, a variation in an ambient temperature or an operation environment without setting fixed values.

(2) While in the present embodiment, the description has been given in the operation example in which a noise removal process or a smoothing process is not performed, the present invention may be configured to perform noise processing or a smoothing process combined with cumulative processing.

It should be understood by those skilled in the art that various modifications, combinations, sub-combinations and alterations may occur depending on design requirements and other factors insofar as they are within the scope of the appended claims of the equivalents thereof.

1. An input device, comprising:
an input operation unit onto which an operating body performs an approach operation, the input operation unit including a plurality of capacitance detection units;
a capacitance measurement unit configured to measure a capacitance value for each of the capacitance detection units and output the measured capacitance value for each of the capacitance detection units as a measurement signal; and
a control unit configured to repeatedly acquire the measurement signal in association with the corresponding capacitance detection unit, obtain a capacitance change value from a difference between the measured capacitance value of the measurement signal and a base value set for the corresponding capacitance detection unit, and determine whether the capacitance change value exceeds a first threshold value to detect whether or not there is an operation onto or approaching the input operation unit,
wherein the control unit is further configured to obtain a sum total of the capacitance change values which are negative values, and compare the sum total with a second threshold value to determine if a foreign object has been removed from the input operation unit, the control unit updating the base value for each of the capacitance detection unites using the measurement signal if no operation is detected or a removal of the foreign object is detected.

2. The input device according to claim 1,
wherein the control unit updates the base value when the sum total of the capacitance change values which are negative values exceeds the second threshold value which is negative.

3. The input device according to claim 1,
wherein the control unit includes a memory unit which stores the first threshold value, the second threshold value and an initial value of the base value for each of the capacitance detection units.

4. The input device according to claim 1, wherein the control unit determines an operation by the operation body at a position on the input operation unit corresponding to the capacitance detection unit having a greatest capacitance change value, if the operation onto or approaching the input operation is detected and no removal of the foreign object is detected.
